(19) United States
(12) Patent Application Publication
(10) Pub. No.: US 2026/0128452 A1
(43) Pub. Date: May 7, 2026

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Kotaro TAKADA, Osaka (JP); Osamu NAKAYAMA, Osaka (JP); Katsushi MIYAZAKI, Osaka (JP); Daiki TSUJI, Osaka (JP)

(21) Appl. No.: 19/117,402

(22) PCT Filed: Oct. 2, 2023
(86) PCT No.: PCT/JP2023/035905

§ 371 Date: Apr. 1, 2025

(30) Foreign Application Priority Data
Oct. 6, 2022 (JP) 2022-161724
Jan. 25, 2023 (JP) 2023-009227

(51) Int. Cl. H01M 50/298; H01M 50/211; H01M 50/503; H01M 50/557

(52) U.S. Cl. CPC H01M 50/298; H01M 50/211; H01M 50/503; H01M 50/557

(57) ABSTRACT

A wiring module is to be attached to a battery stack configured by stacking a plurality of laminated batteries including electrode leads, the battery stack including a joining portion formed by overlapping and joining the electrode leads of the laminated batteries, and provided with a terminal, a wire to be connected to the terminal, and a protector for holding the terminal and the wire. The terminal includes a body portion, a connecting portion extending from the body portion and facing and connected to the electrode leads constituting the joining portion in a first direction, and a bent plate portion connected to the body portion via a bent portion and extending toward the laminated batteries in the first direction.

### TECHNICAL FIELD

The present disclosure relates to a wiring module.

### BACKGROUND

In a high-voltage battery pack used in an electric vehicle, a hybrid vehicle or the like, a multitude of battery cells are normally stacked and electrically connected in series or in parallel by a wiring module. A wiring module described in Japanese Patent Laid-Open Publication No. 2020-527848 (Patent Document 1 below) has been conventionally known as such a wiring module. A battery module described in Patent Document 1 is provided with a cell assembly, in which a plurality of battery cells each including electrode leads in front and rear end parts are stacked in a lateral direction, a module housing configured to accommodate the cell assembly in an internal space formed by four upper, lower, left and right side walls, and end frames assembled in front of and behind the cell assembly to connect the cell assembly to an external device.

### PRIOR ART DOCUMENT

### Patent Document

Patent Document 1: JP 2020-527848 A

### SUMMARY OF THE INVENTION

### Problems to be Solved

In the above configuration, since the cell assembly includes parts where the electrode leads of the adjacent battery cells are bent toward each other, overlapped and electrically connected, it is not necessary to provide busbars for connecting the electrode leads. The electrode leads are electrically connected to module terminals provided in the end frames.

In the above configuration, the electrode leads and the module terminals can be connected by laser welding. In consideration of laser welding efficiency, the module terminals are preferably thin. On the other hand, if the module terminals are thin, the module terminals may be bent when being mounted into the end frames.

### Means to Solve the Problem

The present disclosure is directed to a wiring module to be attached to a battery stack configured by stacking a plurality of laminated batteries including electrode leads, the battery stack including a joining portion formed by overlapping and joining the electrode leads of the laminated batteries, the wiring module being provided with a terminal, a wire to be connected to the terminal and a protector for holding the terminal and the wire, the terminal including a body portion, a connecting portion extending from the body portion and facing and connected to the electrode leads constituting the joining portion in a first direction and a bent plate portion connected to the body portion via a bent portion and extending toward the laminated batteries in the first direction, the protector including a protector body, a recess recessed toward the laminated batteries in the first direction with respect to the protector body, the recess accommodating the bent plate portion, and at least one deflection piece extending from the protector body and deflectable and deformable in a second direction orthogonal to the first direction, the deflection piece including a plurality of plate portions extending in the first direction and arranged apart in the second direction and at least one coupling portion coupling end parts in the first direction of two adjacent ones of the plate portions, the plurality of plate portions including at least a base end side plate portion to be connected to the protector body and a tip side plate portion disposed to face the terminal, the tip side plate portion including a locking portion to be disposed in the recess and locked to the bent plate portion from a side opposite to the laminated batteries in the first direction, and the deflection piece having a bellows shape by alternately connecting the plate portions and the coupling portion from the base end side plate portion to the tip side plate portion.

### Effect of the Invention

According to the present disclosure, it is possible to provide a wiring module in which a terminal is hardly deformed when being mounted into a protector.

### BRIEF DESCRIPTION OF THE DRAWINGS

FIG. 1 is a perspective view showing a front part of a power storage module according to a first embodiment.

FIG. 2 is a front view of the power storage module.

FIG. 3 is a view enlargedly showing the periphery of a terminal in FIG. 2.

FIG. 4 is a section along A-A of FIG. 2.

FIG. 5 is a section along B-B of FIG. 3.

FIG. 6 is a section along B-B of FIG. 3 showing a first position of the terminal.

FIG. 7 is a section along B-B of FIG. 3 showing a second position of the terminal.

FIG. 8 is a section along B-B of FIG. 3 without the terminal.

FIG. 9 is a section along C-C of FIG. 3.

FIG. 10 is a section along D-D of FIG. 5.

FIG. 11 is a perspective view showing the periphery of a terminal accommodating portion in the power storage module.

FIG. 12 is a view with the terminal in FIG. 11 omitted.

FIG. 13 is a perspective view of a front part of a battery stack.

FIG. 14 is a perspective view showing an essential part of a laminated battery.

FIG. 15 is a perspective view showing the terminal connected to a wire.

FIG. 16 is a section along B-B of FIG. 3 showing a state where a deflection piece is deflected when a bent plate portion is inserted into a recess.

FIG. 17 is a perspective view showing the periphery of a deflection piece according to a second embodiment.

FIG. 18 is a section of a power storage module showing a cross-section corresponding to FIG. 5 of the first embodiment.

FIG. 19 is a section of the power storage module showing a cross-section corresponding to FIG. 9 of the first embodiment.

FIG. 20 is a perspective view showing the periphery of a deflection piece according to a third embodiment.

FIG. 21 is a perspective view showing slits of an inner wall of a deflection piece accommodation recess.

FIG. 22 is a section of a power storage module showing a cross-section corresponding to FIG. 5 of the first embodiment.

FIG. 23 is a section of a power storage module according to another embodiment showing a cross-section corresponding to FIG. 5 of the first embodiment.

### DETAILED DESCRIPTION TO EXECUTE THE INVENTION

### Description of Embodiments of Present Disclosure

First, embodiments of the present disclosure are listed and described.

(1) The wiring module of the present disclosure is to be attached to a battery stack configured by stacking a plurality of laminated batteries including electrode leads, the battery stack including a joining portion formed by overlapping and joining the electrode leads of the laminated batteries, and provided with a terminal, a wire to be connected to the terminal and a protector for holding the terminal and the wire, the terminal including a body portion, a connecting portion extending from the body portion and facing and connected to the electrode leads constituting the joining portion in a first direction and a bent plate portion connected to the body portion via a bent portion and extending toward the laminated batteries in the first direction, the protector including a protector body, a recess recessed toward the laminated batteries in the first direction with respect to the protector body, the recess accommodating the bent plate portion, and at least one deflection piece extending from the protector body and deflectable and deformable in a second direction orthogonal to the first direction, the deflection piece including a plurality of plate portions extending in the first direction and arranged apart in the second direction and at least one coupling portion coupling end parts in the first direction of two adjacent ones of the plate portions, the plurality of plate portions including at least a base end side plate portion to be connected to the protector body and a tip side plate portion disposed to face the terminal, the tip side plate portion including a locking portion to be disposed in the recess and locked to the bent plate portion from a side opposite to the laminated batteries in the first direction, and the deflection piece having a bellows shape by alternately connecting the plate portions and the coupling portion from the base end side plate portion to the tip side plate portion.

According to this configuration, since the deflection piece includes the plurality of plate portions and at least one coupling portion coupling the two adjacent ones of the plate portions and has the bellows shape, stress necessary to deflect the deflection piece can be reduced. Therefore, the bending of the terminal can be suppressed when the terminal is mounted into the protector by inserting the bent plate portion into the recess.

(2) Preferably, the protector is formed with a plurality of electrode accommodation recesses penetrating through the protector body in the first direction, the electrode accommodation recesses receiving the electrode leads, the plurality of electrode accommodation recesses are arranged in a third direction orthogonal to both the first and second directions, and the deflection piece is disposed between two adjacent ones of the electrode accommodation recesses.

According to this configuration, since the plurality of electrode accommodation recesses are arranged in the third direction, this wiring module is attached to the battery stack configured by stacking the plurality of laminated batteries in the third direction. Since a space extending in the first and second directions is formed between the electrode leads adjacent in the third direction, a deflection margin of the deflection piece can be increased by disposing the deflection piece in this space. Further, the wiring module can be reduced in size.

(3) Preferably, the tip side plate portion is connected to the coupling portion on an end part opposite to the laminated batteries in the first direction.

According to this configuration, the bent plate portion can be suppressed from being erroneously inserted between the tip side plate portion and the plate portion adjacent to the tip side plate portion when the bent plate portion is inserted into the recess.

(4) Preferably, the tip side plate portion includes a locking projection projecting from the tip side plate portion toward a side opposite to the base end side plate portion in the second direction, the locking projection includes the locking portion disposed on the laminated battery side in the first direction and an inclined portion disposed further on the side opposite to the laminated batteries in the first direction than the locking portion, and the inclined portion is located more away from the base end side plate portion in the second direction toward the laminated batteries in the first direction.

According to this configuration, the insertion of the bent plate portion into the recess and the locking of the bent plate portion and the locking portion can be smoothly performed by the inclined portion. (5) Preferably, the tip side plate portion is located more away from the base end side plate portion in the second direction toward the laminated batteries in the first direction.

According to this configuration, the bent plate portion can be smoothly inserted into the recess by the tip side plate portion.

(6) Preferably, the protector includes a guide portion disposed to be continuous with an inner wall of the recess further on the side opposite to the laminated batteries in the first direction than the recess, and the guide portion is inclined inwardly of the recess toward the laminated batteries in the first direction.

According to this configuration, the insertion of the bent plate portion into the recess can be guided by the guide portion.

(7) Preferably, the protector includes a deflection piece accommodation recess recessed from the protector body toward the laminated batteries in the first direction, the deflection piece accommodation recess accommodating a part of the deflection piece.

According to this configuration, the part of the deflection piece can be protected by accommodating the part of the deflection piece into the deflection piece accommodation recess.

(8) Preferably, an inner wall constituting the deflection piece accommodation recess extends in the first direction and includes a pair of slits disposed side by side in a third direction orthogonal to both the first and second directions, and the inner wall disposed between the pair of slits serves as the base end side plate portion.

According to this configuration, since the base end side plate portion can be configured, utilizing the inner wall of the deflection piece accommodation recess, a space for forming the deflection piece can be reduced.

(9) Preferably, the terminal is formed with at least one opening penetrating through the bent plate portion, and an opening edge part of the opening includes a lock receiving portion to be locked to the locking portion.

According to this configuration, the lock receiving portion to be locked to the locking portion can be easily provided by forming the opening in the bent plate portion. Further, a space for locking the bent plate portion and the locking portion can be reduced.

### DETAILS OF EMBODIMENTS OF PRESENT DISCLOSURE

Hereinafter, embodiments of the present disclosure are described. The present disclosure is not limited to these illustrations, but is represented by claims and intended to include all changes in the scope of claims and in the meaning and scope of equivalents.

### First Embodiment

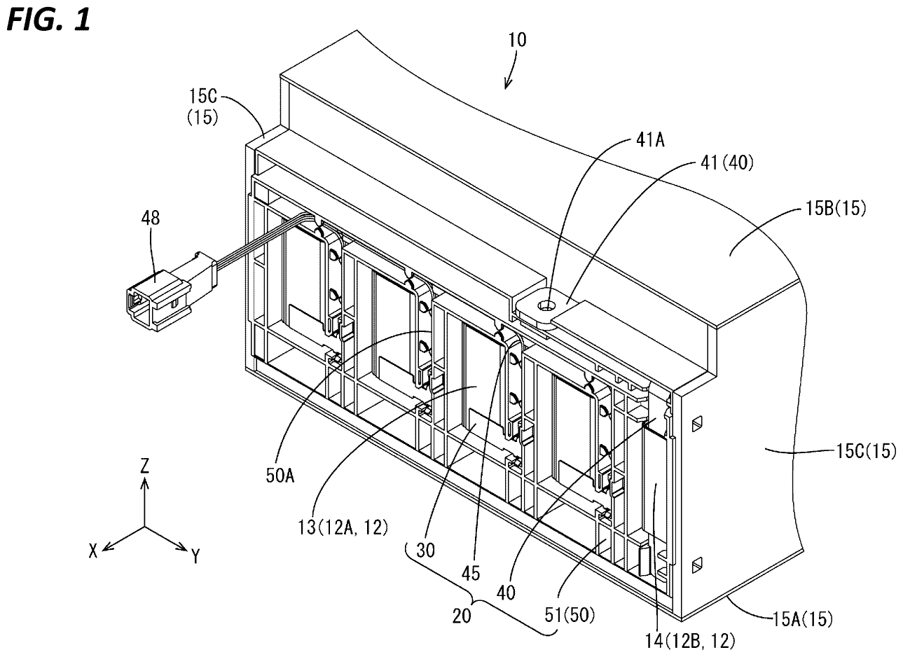

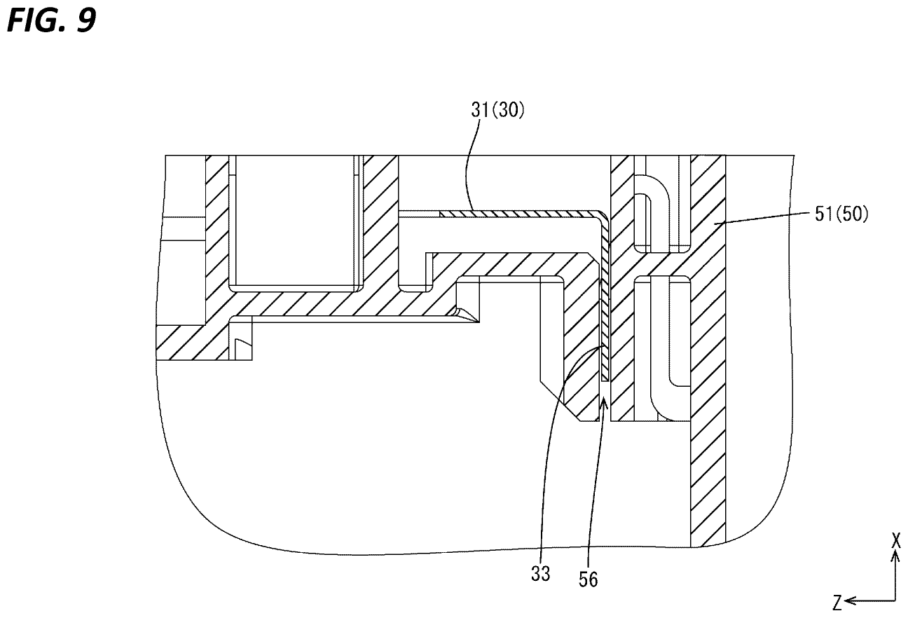

A first embodiment of the present disclosure is described with reference to FIGS. 1 to 16. A power storage module 10 provided with a wiring module 20 of this embodiment is, for example, installed in a vehicle such as an electric vehicle or a hybrid vehicle and used as a drive source of the vehicle. In the following description, for a plurality of identical members, only some members may be denoted by a reference sign and the other members may not be denoted by the reference sign. A direction indicated by an arrow X is referred to as a forward direction, a direction indicated by an arrow Y is referred to as a leftward direction and a direction indicated by an arrow Z is referred to as an upward direction. In this embodiment, a front-rear direction is an example of a first direction, a vertical direction is an example of a second direction and a lateral direction is an example of a third direction.

### [Battery Stack]

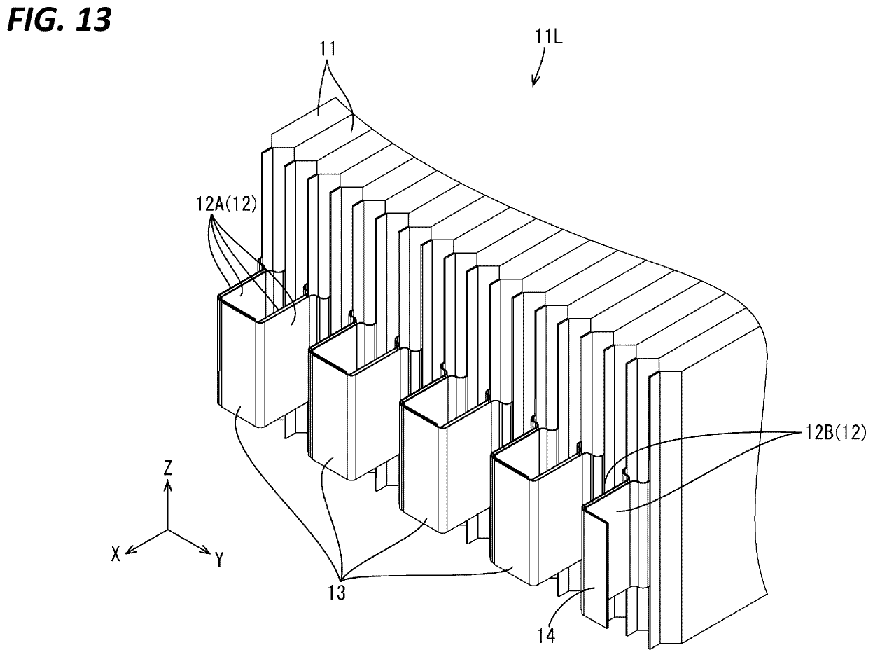

The power storage module 10 is provided with a battery stack 11L shown in FIG. 13 and a wiring module 20 to be to be attached to the battery stack 11L shown in FIG. 1. As shown in FIG. 1, the power storage module 10 of this embodiment is provided with an enclosure 15 for covering the battery stack 11L from four upper, lower, left and right sides. The enclosure 15 is composed of a bottom portion 15A to be disposed on a lower surface side of the battery stack 11L, a ceiling portion 15B to be disposed on an upper surface side of the battery stack 11L and a pair of side portions 15C for connecting the bottom portion 15A and the ceiling portion 15B on both left and right sides.

### [Laminated Batteries, Electrode Leads]

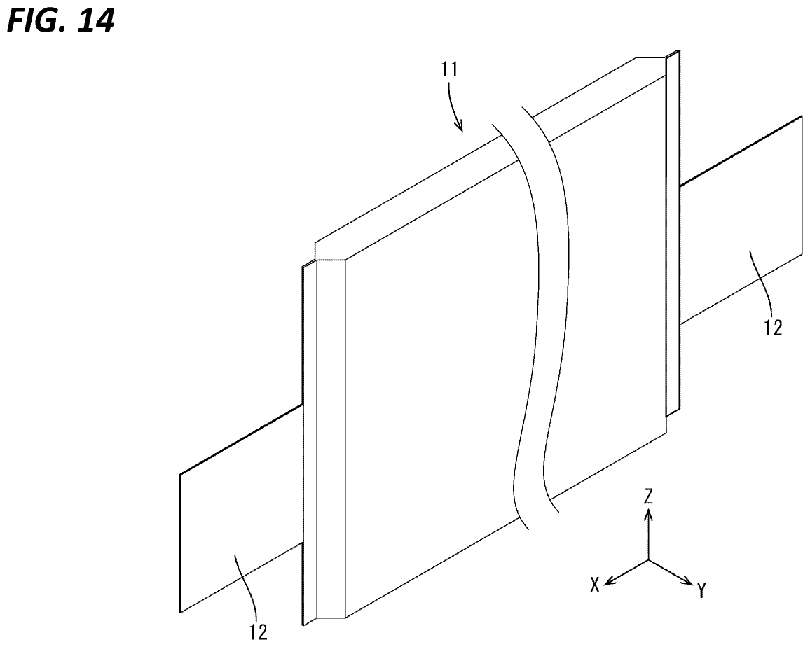

As shown in FIG. 13, the battery stack 11L is configured by stacking a plurality of (eighteen in this embodiment) laminated batteries 11 in the lateral direction. Note that only a front part of the battery stack 11L is shown in FIG. 13. As shown in FIG. 14, the laminated battery 11 has a shape long in the front-rear direction and flat in the lateral direction. A power storage element (not shown) is accommodated inside the laminated battery 11. A pair of electrode leads 12 are arranged on both sides in the front-rear direction of the laminated battery 11 and project in directions opposite to each other. The pair of electrode leads 12 are plate-like and have polarities opposite to each other.

### [Joining Portions]

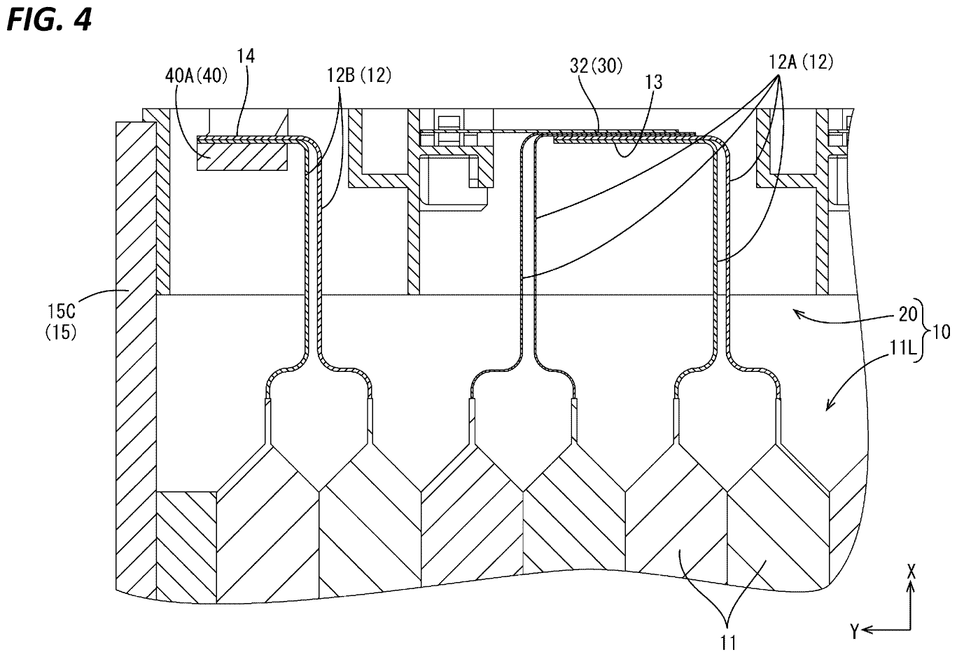

As shown in FIGS. 4 and 13, the battery stack 11L is provided with joining portions 13 each for electrically connecting four electrode leads 12 of the laminated batteries 11 successively arranged in the lateral direction. That is, four electrode leads 12 are bent leftward or rightward substantially at a right angle, overlapped and joined by laser welding, whereby the joining portion 13 is configured. The electrode leads 12 constituting the joining portion 13 are connection electrode leads 12A. Out of the four connection electrode leads 12A, two connection electrode leads 12A disposed on a right side and the two connection electrode leads 12A disposed on a left side have polarities opposite to each other. For example, the two connection electrode leads 12A disposed on the right side have a positive polarity and the two connection electrode leads 12A disposed on the left side have a negative polarity. Therefore, in the battery stack 11L, the joining portion 13 connects in series two laminated batteries 11 connected in parallel. As shown in FIG. 13, the battery stack 11L is provided with four joining portions 13 in a front part. Note that, although not shown, the battery stack 11L is also provided with four joining portions 13 in a rear part.

Since a forming process of the joining portion 13 includes bending of the electrode leads 12, laser welding and the like, a tolerance of the joining portion 13 (and the connection electrode leads 12A) in the front-rear direction particularly tends to increase. For example, in this embodiment, the tolerance in the front-rear direction of the joining portion 13 (and the connection electrode leads 12A) is a numerical value larger than a thickness of the electrode leads 12.

As shown in FIGS. 4 and 13, the battery stack 11L is provided with an output portion 14 in a left end part of the front part. Note that, although not shown, the battery stack 11L is also provided with an output portion 14 in a right end part of the rear part. The output portion 14 is configured by joining two electrode leads 12 not constituting the joining portion 13, out of the electrode leads 12. The electrode leads 12 constituting the output portion 14 are output electrode leads 12B. The two output electrode leads 12B constituting one output portion 14 have the same polarity. The output portion 14 constitutes a positive polarity or a negative polarity of the entire battery stack 11L. That is, for example, if the front output portion 14 has a total positive polarity of the battery stack 11L, the rear output portion 14 has a total negative polarity of the battery stack 11L.

### [Wiring Module]

As shown in FIG. 1, the wiring module 20 of this embodiment is provided with terminals 30 to be connected to the connection electrode leads 12A, busbars 40 to be connected to the output electrode leads 12B, wires 45 to be connected to the terminals 30 and a protector 50 for holding the terminals 30, the busbars 40 and the wires 45. The configuration of the wiring module 20 to be disposed on a front side of the power storage module 10 is described in detail below. Although not shown, the wiring module 20 to be disposed on a rear side of the power storage module 10 has the same configuration as the wiring module 20 to be disposed on the front side of the power storage module 10.

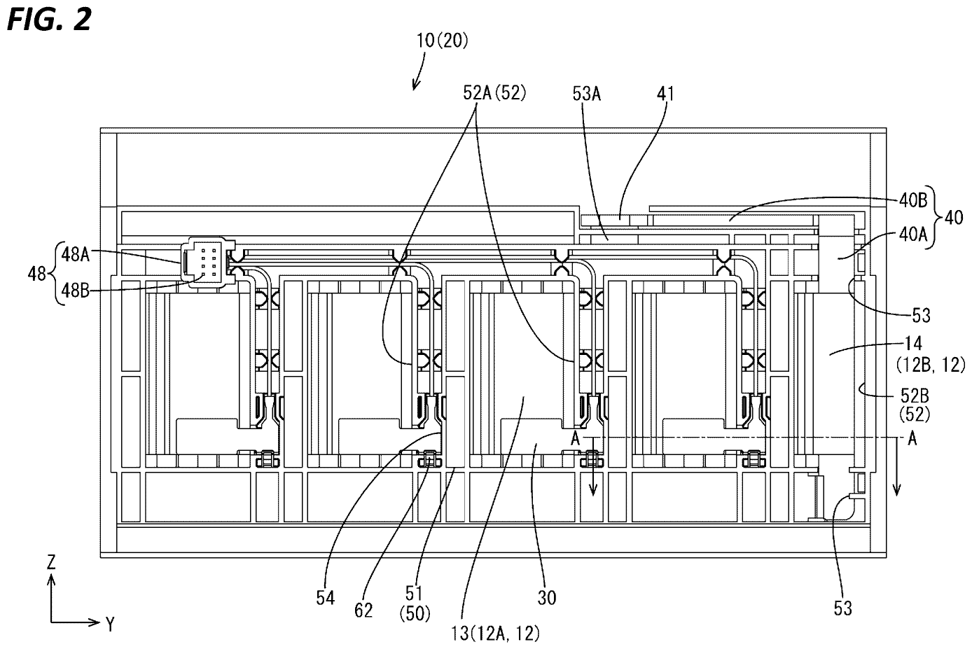

The busbar 40 has a plate-like shape and is formed by working an electrically conductive metal plate material. As shown in FIG. 2, the busbar 40 includes a first part 40A extending in the vertical direction and a second part 40B connected to an upper end part of the first part 40A. The first part 40A is flat in the front-rear direction. The second part 40B extends rightward from the upper end part of the first part 40A and is flat in the vertical direction. The busbar 40 is held in busbar holding portions 53 of the protector 50 and connected to the output electrode leads 12B in a vertical central part of the first part 40A. A right end part of the second part 40B is provided with a busbar side connecting portion 41.

As shown in FIG. 1, the busbar side connecting portion 41 includes a through hole 41A, into which a bolt is inserted. An unillustrated external connection terminal is overlaid on the busbar side connecting portion 41, and bolt-fastened to the busbar side connecting portion 41. In this way, the busbar side connecting portion 41 is electrically connected to the external connection terminal. The external connection terminal is used to connect an unillustrated external device and the power storage module 10.

### [Wires]

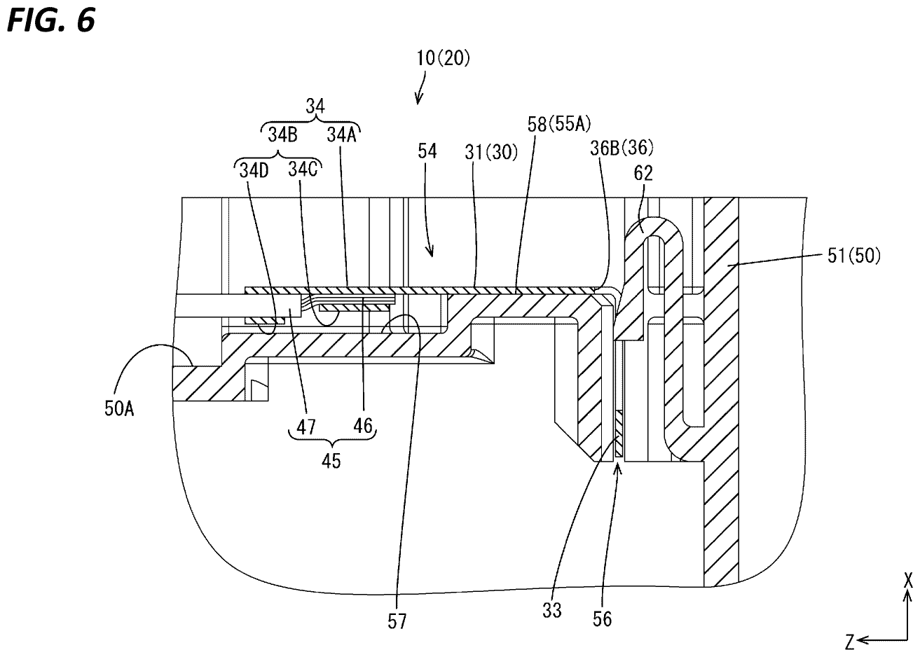

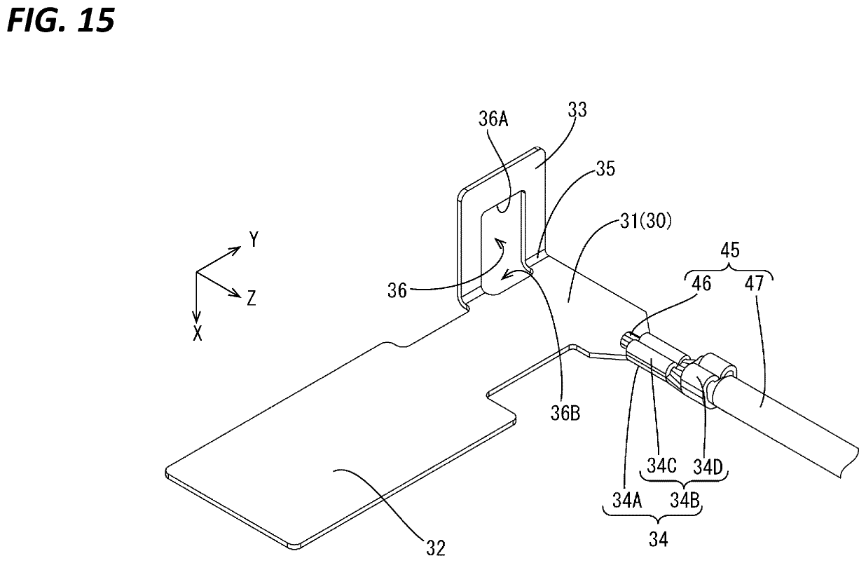

As shown in FIGS. 6 and 15, the wire 45 includes a core wire 46 and an insulation coating 47 covering the core wire 46. One end part of the wire 45 is connected to the terminal 30. As shown in FIG. 1, the other end parts of the wires 45 are bundled into one and connected to a connector 48. The wires 45 are routed in routing recesses 50A of the protector 50 and routed at predetermined positions.

As shown in FIG. 2, the connector 48 is provided with a housing 48A made of insulating synthetic resin and a male terminal 48B to be accommodated into the housing 48A. The connector 48 is connected to a mating connector (not shown) including a female terminal. The mating connector is connected to an external ECU (Electronic Control Unit) or the like via an unillustrated wire. The ECU is installed with a microcomputer, elements and the like and has a known configuration provided with functions of detecting a voltage, a current, a temperature and the like of each laminated battery 11 and controlling the charge and discharge of each laminated battery 11.

### [Terminal]

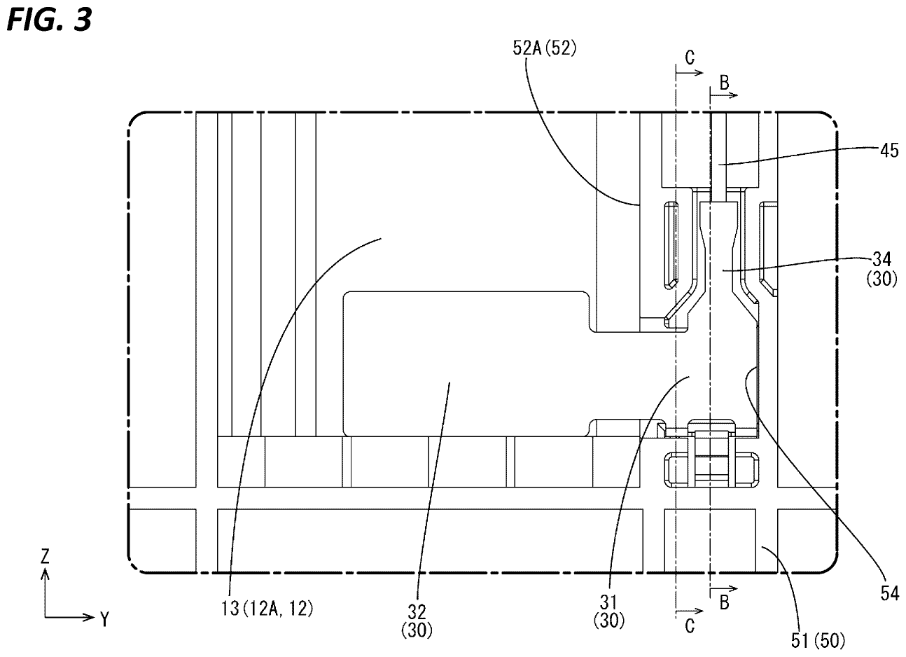

As shown in FIG. 15, the terminal 30 is provided by working an electrically conductive metal plate material. The terminal 30 includes a body portion 31, a connecting portion 32 extending rightward from the body portion 31, a bent plate portion 33 extending rearward from a lower part of the body portion 31 and a wire connecting portion 34 extending upward from the body portion 31. As shown in FIG. 3, the body portion 31 is disposed on a right side of the terminal 30 and has a rectangular shape in a front view. The body portion 31 is so accommodated into a terminal accommodating portion 54 that a plate thickness direction is the front-rear direction.

### [Connecting Portion]

As shown in FIG. 15, the connecting portion 32 has a rectangular shape long in the lateral direction and is formed to be flush with the body portion 31. The connecting portion 32 projects further upward and downward than the body portion 31 in the vertical direction. As shown in FIG. 4, the connecting portion 32 is held in surface contact with and connected to the joining portion 13 or a part of the connection electrode lead 12A constituting the joining portion 13. That is, the terminal 30 is not a member for connecting the adjacent connection electrode leads 12A, but a member for connecting the connection electrode lead 12A (joining portion 13) connected in advance and the wire 45. Thus, a vertical dimension of the connecting portion 32 may be smaller than that of the connection electrode lead 12A.

### [Bent Plate Portion]

As shown in FIG. 15, the bent plate portion 33 is bent substantially perpendicular to the body portion 31 and formed to extend rearward. The bent plate portion 33 is so disposed that a plate thickness direction is the vertical direction. A lower end part of the body portion 31 and a front end part of the bent plate portion 33 are connected via a bent portion 35. A plate thickness direction of the bent portion 35 changes from the front-rear direction to the vertical direction as extending from the body portion 31 toward the bent plate portion 33.

### [Opening, Lock Receiving Portion]

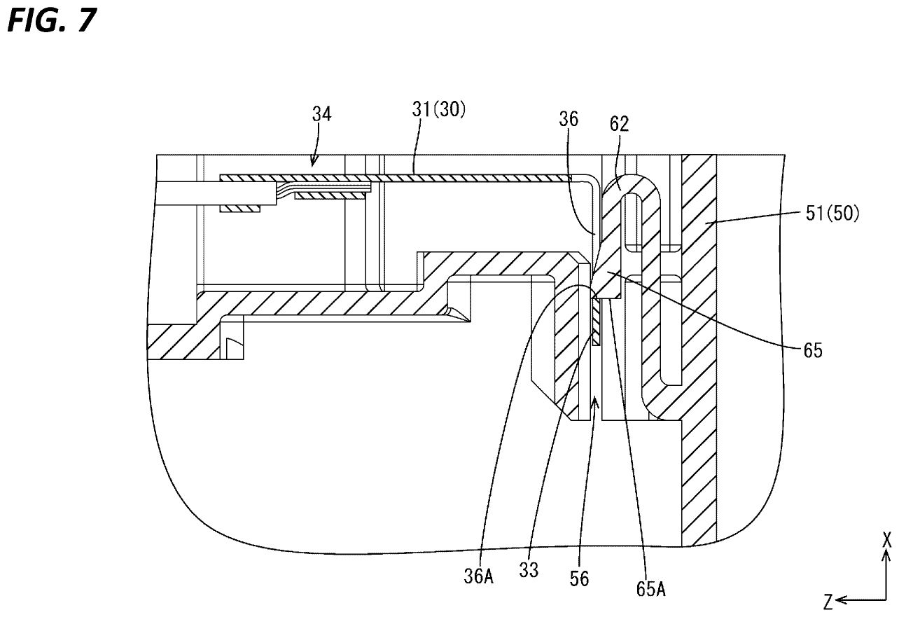

The bent plate portion 33 is formed with an opening 36 penetrating in the vertical direction. The opening 36 is disposed in a lateral central part of the bent plate portion 33. Out of an opening edge part of the opening 36, the opening edge part on the rear side serves as a lock receiving portion 36A. As shown in FIG. 7, the lock receiving portion 36A is lockable to a locking portion 65A of a deflection piece 62 to be described later. As shown in FIG. 15, the opening 36 includes an extended opening 36 spreading to the side of the body portion 31. By forming the extended opening 36B, the lower end part of the body portion 31 does not interfere with the deflection piece 62 (see FIG. 6) when the terminal 30 moves in the front-rear direction with respect to the protector 50.

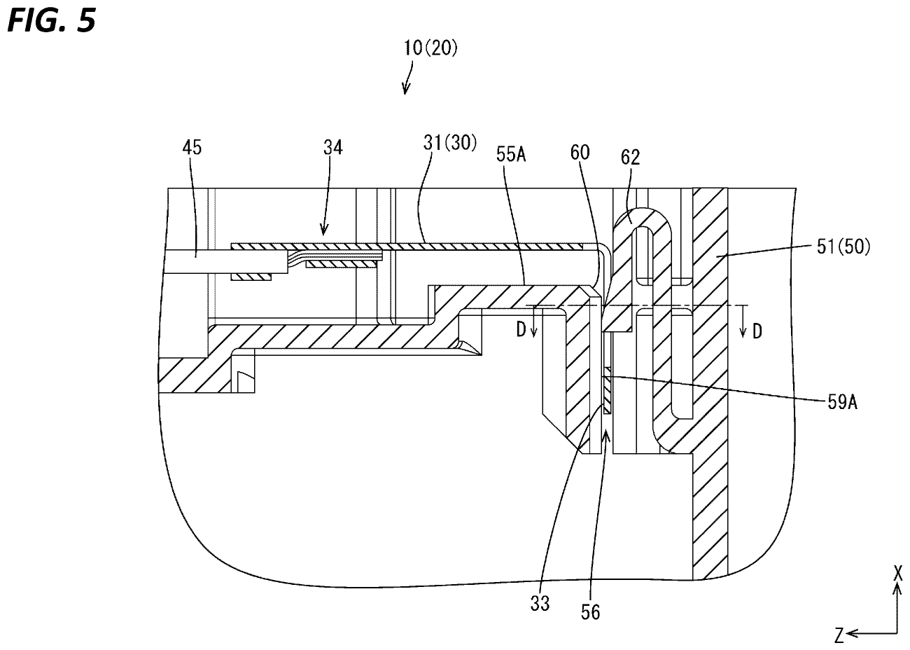

As shown in FIGS. 6 and 15, the wire connecting portion 34 includes a base portion 34A flush with the body portion 31 and crimping pieces 34B extending from both ends in the lateral direction of the base portion 34A. The crimping piece 34 includes a first crimping piece 34C and a second crimping piece 34D disposed apart from the first crimping piece 34C in the front-rear direction. The first crimping piece 34C is disposed on the side of the wire connecting portion 34 near the body portion 31 and crimped to the core wire 46 of the wire 45. The second crimping piece 34D is disposed on an upper end part of the wire connecting portion 34 and crimped to the insulation coating 47 of the wire 45. Note that the wire connecting portion 34 is shown in a simplified manner except in FIGS. 5 to 7, 15 and 16.

As shown in FIG. 6, the crimping piece 34B is crimped to the wire 45 behind the base portion 34A. The wire connecting portion 34 disposed behind the body portion 31 is disposed in a wire connecting portion accommodating portion 57 to be described later. By such a configuration, a dimension in the front-rear direction of the wiring module 20 can be reduced.

### [Protector, Electrode Accommodation Recesses]

The protector 50 is made of insulating synthetic resin and plate-like as shown in FIG. 1. The protector 50 includes a protector body 51 to be positioned with respect to the enclosure 15 (and the battery stack 11L). As shown in FIG. 2, the electrode accommodation recesses 52 are provided in parallel to the lateral direction in a vertical central part of the protector body 51. The electrode accommodation recess 52 is formed to penetrate in the front-rear direction and has a vertically long rectangular shape. The electrode accommodation recesses 52 include connection electrode accommodation recesses 52A for receiving the joining portions 13 and the connection electrode leads 12A and an output electrode accommodation recess 52B for receiving the output electrode leads 12B and the output portion 14.

As shown in FIG. 2, the busbar holding portions 53 for holding the busbar 40 are provided on upper and lower sides of the output electrode accommodation recess 52B. A bolt fastening portion 53A for bolt-fastening the busbar 40 is provided to the right of the upper busbar holding portion 53. The terminal accommodating portion 54 for accommodating a part of the terminal 30 is provided on an oblique left lower side of the connection electrode accommodation recess 52A.

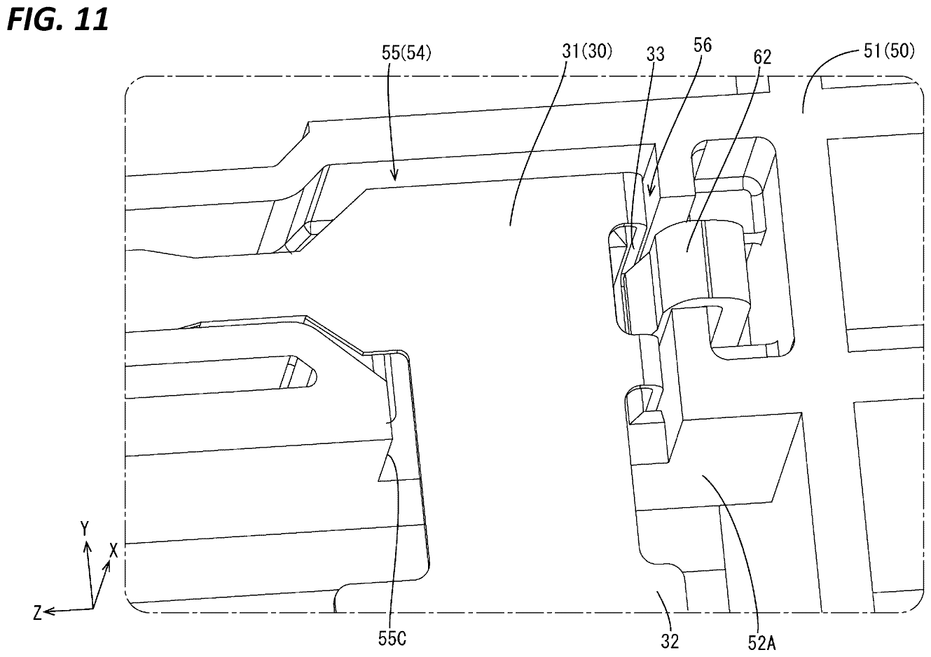

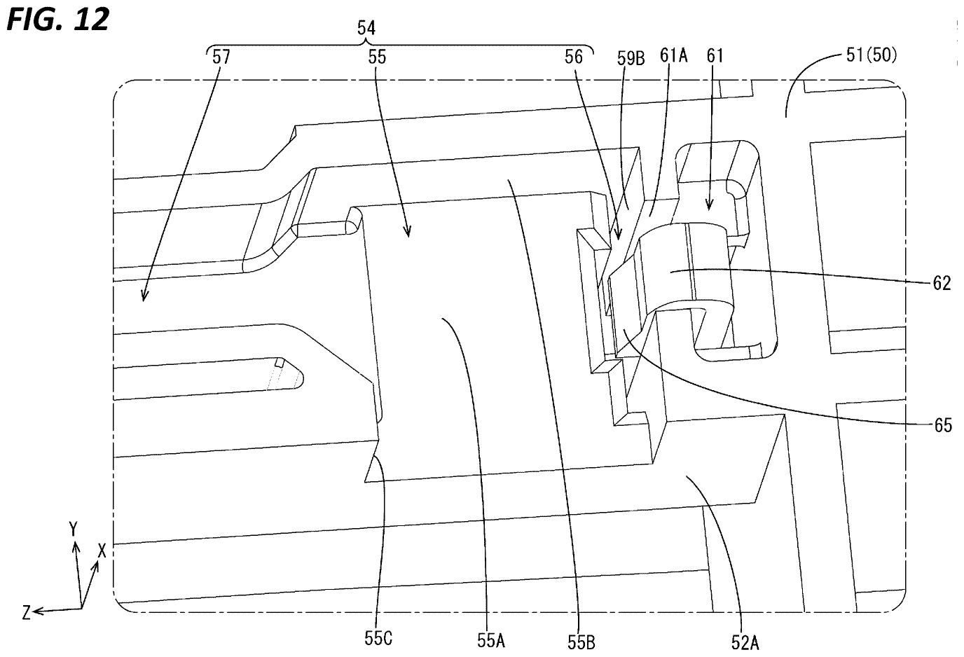

As shown in FIG. 12, the terminal accommodating portion 54 is formed to be recessed rearward from the protector body 51. The terminal accommodating portion 54 includes a body portion accommodating portion 55, a recess 56 and the wire connecting portion accommodating portion 57. The body portion accommodating portion 55 is disposed in a lower part of the terminal accommodating portion 54. The body portion accommodating portion 55 includes a bottom wall portion 55A, a left wall portion 55B extending forward from a left end part of the bottom wall portion 55A and a communication hole 55C open rightward. The communication hole 55C communicates with the connection electrode accommodation recess 52A. As shown in FIG. 11, the body portion accommodating portion 55 accommodates the body portion 31 of the terminal 30. As shown in FIG. 6, the front surface of the bottom wall portion 55A serves as a contact portion 58 for contacting the terminal 30 from behind. As shown in FIG. 11, a part of the body portion 31 on the side of the connecting portion 32 is disposed in the communication hole 55C and the connecting portion 32 is disposed inside the connection electrode accommodation recess 52A.

### [Recess]

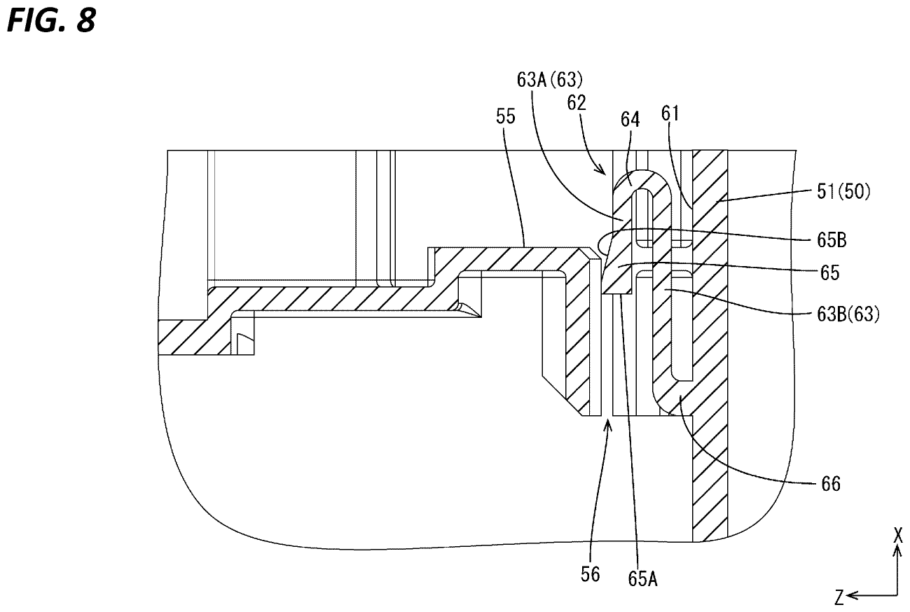

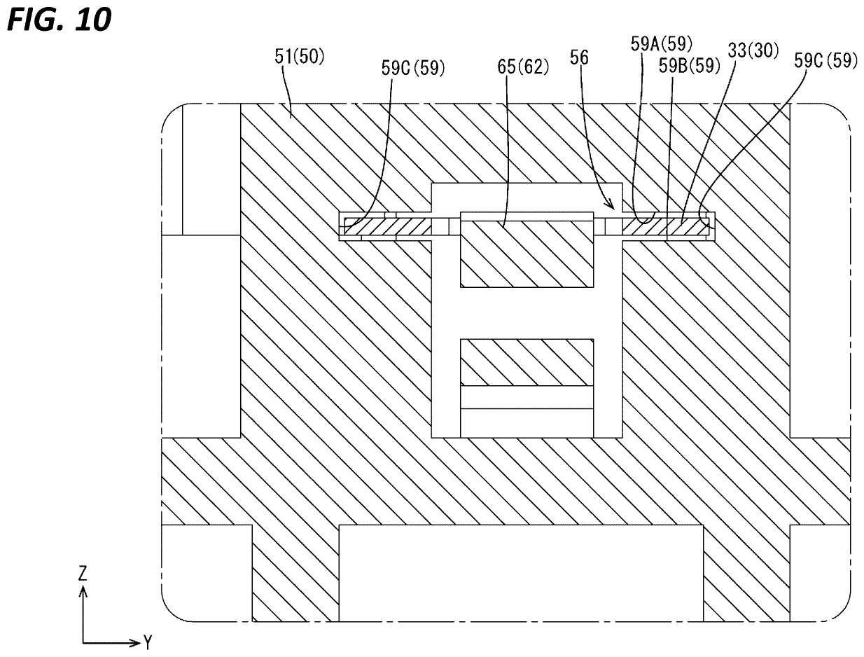

As shown in FIGS. 8 and 12, the recess 56 is formed below the body portion accommodating portion 55. The recess 56 is recessed further rearward than the body portion accommodating portion 55. The recess 56 is formed to penetrate through the protector 50 in the front-rear direction. As shown in FIG. 10, an inner wall 59 constituting the recess 56 includes a first inner wall 59A and a second inner wall 59B facing each other in the vertical direction and two side walls 59C facing each other in the lateral direction. The first inner wall 59A is disposed above (on the side of the body portion accommodating portion 55) the second inner wall 59B. A dimension between the first and second inner walls 59A, 59B is set to be equal to or somewhat larger than a plate thickness (vertical dimension) of the bent plate portion 33. A dimension between the two side walls 59C is set to be equal to or somewhat larger than a lateral dimension of the bent plate portion 33. The bent plate portion 33 is accommodated inside the recess 56, and the bent plate portion 33 and the inner wall 59 of the recess 56 can slide in contact. By the sliding contact of the bent plate portion 33 and the inner wall 59 of the recess 56, the terminal 30 can move in the front-rear direction with respect to the protector body 51 as shown in FIGS. 5 to 7 and 9.

### [Guide Portion]

As shown in FIG. 5, a guide portion 60 is formed on a front side of a lower end part of the bottom wall portion 55A. The guide portion 60 is connected to a front side of the first inner wall 59A of the recess 56. The guide portion 60 is inclined to be located lower toward the rear side. The guide portion 60 is configured to introduce and guide a rear end part of the bent plate portion 33 into the recess 56 when the bent plate portion 33 is inserted into the recess 56.

As shown in FIG. 12, the wire connecting portion accommodating portion 57 is connected to an upper part of the body portion accommodating portion 55. As shown in FIG. 6, the wire connecting portion accommodating portion 57 is formed to be recessed further rearward than the bottom wall portion 55A. Specifically, the front surface of the wire connecting portion accommodating portion 57 is set at a position not to be contacted by the wire connecting portion 34 with the body portion 31 of the terminal 30 disposed in the terminal accommodating portion 54 held in contact with the front surface (contact portion 58) of the bottom wall portion 55A. An upper part of the wire connecting portion accommodating portion 57 is connected to the routing recess 50A in which the wire 45 is routed.

### [Deflection Piece Accommodation Recess, Deflection Piece]

As shown in FIG. 12, a deflection piece accommodation recess 61 is formed to be recessed rearward from the protector body 51 below the recess 56. An entrance opening 61A is formed to be recessed rearward from the upper end of the second inner wall 59B in the second inner wall 59B between the recess 56 and the deflection piece accommodation recess 61. The entrance opening 61A allows communication between the recess 56 and the deflection piece accommodation recess 61. As shown in FIG. 8, the deflection piece 62 extends upward from the lower inner wall of the deflection piece accommodation recess 61. As shown in FIG. 12, a tip part of the deflection piece 62 is located in the recess 56 by disposing a part of the deflection piece 62 inside the entrance opening 61A.

### [Plate Portions, Coupling Portion, Tip Side Plate Portion, Base End Side Plate Portion]

As shown in FIG. 8, the deflection piece 62 includes a plurality of (two in this embodiment) plate portions 63 long in the front-rear direction and flat in the vertical direction and a coupling portion 64 coupling the two adjacent plate portions 63. In this embodiment, the plurality of plate portions 63 include a tip side pp 63A disposed on a tip side (upper side) of the deflection piece 62 and a base end side plate portion 63B disposed on a base end side (lower side) of the deflection piece 62. The tip side plate portion 63A and the base end side plate portion 63B are disposed to overlap while being spaced apart in the vertical direction. A front end part of the tip side plate portion 63A and that of the base end side plate portion 63B are smoothly coupled without any step by the arched coupling portion 64. A rear end part of the base end side plate portion 63B is connected to the lower inner wall of the deflection piece accommodation recess 61 via a base end connecting portion 66. The deflection piece 62 is deflectable and deformable in the vertical direction.

In the deflection piece 62 of this embodiment, the plurality of plate portions 63 and the coupling portion 64 are connected in the order of the base end side plate portion 63B, the coupling portion 64 and the tip side plate portion 63A from a base end side toward a tip side of the deflection piece 62. That is, the plate portions 63 and the coupling portion 64 are alternately disposed in the vertical direction. In this way, the deflection piece 62 has a bellows shape. As shown in FIG. 2, in this embodiment, the deflection piece 62 is arranged in a relatively large space between the electrode accommodation recesses 52, whereby a deflection margin of the deflection piece 62 is easily ensured without enlarging the wiring module 20.

### [Locking Projection, Locking Portion, Inclined Portion]

As shown in FIG. 8, the tip side plate portion 63A includes a locking projection 65 projecting upward from the upper surface of the tip side plate portion 63A. The locking projection 65 is disposed on a rear end part of the tip side plate portion 63A. The rear end surface of the locking projection 65 serves as the locking portion 65A. An inclined portion 65B is disposed on a front part of the locking projection 65. The inclined portion 65B is inclined to be located higher toward the rear side. The locking portion 65A and the inclined portion 65B are connected in the front-rear direction. The locking projection 65 is disposed in a front space in the recess 56.

### [Mounting of Terminals Into Protector]

The terminals 30 and the protector 50 are configured as described above. The mounting of the terminals 30 into the protector 50 is described below.

In mounting the terminal 30 into the protector 50, the bent plate portion 33 is specifically inserted into the recess 56 from front. Since the coupling portion 64 is connected to the front end part of the tip side plate portion 63A in this embodiment, the bent plate portion 33 is prevented from being erroneously inserted between the tip side plate portion 63A and the base end side plate portion 63B. On the front end edge of the recess 56, the bent plate portion 33 slides in contact with the guide portion 60 and the inclined portion 65B of the locking projection 65, thereby being guided into the recess 56.

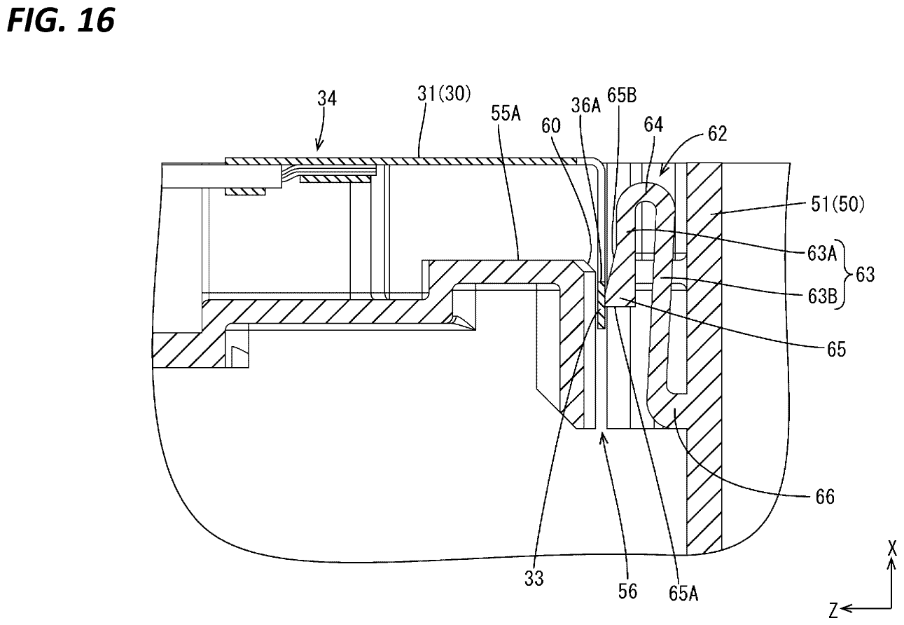

As the bent plate portion 33 is moved rearward toward the back of the recess 56 while the rear end part of the bent plate portion 33 is pressed against the inclined portion 65B of the locking projection 65, the deflection piece 62 is deflected downward as shown in FIG. 16. The coupling portion 64, the locking projection 65 and the base end connecting portion 66 are deformed and each plate portion 63 is displaced to be inclined from the posture thereof in a natural state, whereby the entire deflection piece 62 is deflected. Specifically, the base end side plate portion 63B is so displaced that a front end part thereof is disposed below the rear end part thereof, and the tip side plate portion 63B is so displaced that the rear end part thereof is disposed below the front end part thereof.

As just described, since the deflection piece 62 of this embodiment includes a plurality of deformable parts (coupling portion 64, locking projection 65 and base end connecting portion 66), stress necessary to deflect the deflection piece 62 is reduced. This can be reasoned from the fact that a composite spring constant of a series spring formed by connecting a plurality of springs in series is smaller than an individual spring constant. Further, since the plate portions 63 are displaced to be inclined between the deformable parts, a deflection margin of the deflection piece 62 associated with displacements of the plate portions 63 can be increased by providing the plurality of plate portions 63. From the above, the stress necessary to deflect the deflection piece 62 is reduced in the deflection piece 62 of this embodiment. In other words, the deflection piece 62 can be largely deflected by small stress. Therefore, in mounting the terminal 30 into the protector 50, stress applied to the terminal 30 can be reduced and the deformation of the terminal 30 can be suppressed.

Note that a deformation mode of the deflection piece 62 shown in FIG. 16 is merely an example. A configuration in which the deformation of the respective parts of the deflection piece 62 is different from that in FIG. 16 is also included in the present disclosure. For example, a configuration in which the plate portions 63 are not displaced to be inclined, but resiliently deformed is also in the scope of the present disclosure.

If the bent plate portion 33 is moved further rearward, the deflection piece 62 returns to the natural state from a resiliently deformed state when the rear end surface (locking portion 65A) of the locking projection 65 is disposed in the opening 36 of the bent plate portion 33. Then, the locking portion 65A and the lock receiving portion 36A face each other in the front-rear direction and enter a lockable state (see FIG. 7). By disposing the inclined portion 65B side by side with the locking portion 65A in the front-rear direction in this way, the bent plate portion 33 and the locking portion 65A can be smoothly locked while the insertion of the bent plate portion 33 into the recess 56 is guided.

Further, in this embodiment, the terminal 30 can move in the front-rear direction with respect to the protector 50 by disposing the bent plate portion 33 of the terminal 30 into the recess 56 of the terminal accommodating portion 54. The terminal 30 is movable in the front-rear direction between a first position (see FIG. 6) and a second position (see FIG. 7) with respect to the protector body 51. Here, the first position is a rearmost position, to which the terminal 30 is movable, and the second position is a foremost position, to which the terminal 20 is movable. As shown in FIG. 6, the rear surface of the body portion 31 is in contact with the contact portion 58 with the terminal 30 disposed at the first position. In this way, a rearward movement of the terminal 30 is restricted. As shown in FIG. 7, the lock receiving portion 36A of the terminal 30 and the locking portion 65A of the deflection piece 62 are locked with the terminal 30 disposed at the second position. In this way, a forward movement of the terminal 30 is restricted.

A length in the front-rear direction between the first and second positions is set to be equal to or larger than twice the tolerance in the front-rear direction of the connection electrode lead 12A. Further, a middle position between the first and second positions is an average position in the front-rear direction of the connection electrode lead 12A. By setting the first and second positions in this way, the terminal 30 can follow the connection electrode leads 12A after the protector body 51 of the wiring module 20 is fixed to the battery stack 11L. In particular, in laser-welding the terminal 30 and the connection electrode leads 12A, the connecting portion 32 of the terminal 30 is pressed against the connection electrode leads 12A by a jig or the like. At this time, the terminal 30 moves in the front-rear direction together with the connection electrode leads 12A. Therefore, a state where the connecting portion 32 and the connection electrode leads 12A are held in close contact is ensured and the connecting portion 32 and the connection electrode leads 12A are satisfactorily laser-welded.

### [Functions and Effects of First Embodiment]

According to the first embodiment, the following functions and effects are achieved.

The wiring module 20 according to the first embodiment is to be attached to the battery stack 11L configured by stacking the plurality of laminated batteries 11 including the electrode leads 12 and provided with the joining portions 13 formed by overlapping and joining the electrode leads 12 of the laminated batteries 11, and provided with the terminals 30, the wires 45 to be connected to the terminals 30, and the protector 50 for holding the terminals 30 and the wires 45. The terminal 30 includes the body portion 31, the connecting portion 32 extending from the body portion 31 and facing and connected to the electrode leads 12 constituting the joining portion 13 in the first direction (front-rear direction) and the bent plate portion 33 connected to the body portion 31 via the bent portion 35 and extending toward the laminated batteries 11 (rearward) in the first direction. The protector 50 includes the protector body 51, the recess 56 recessed toward the laminated batteries 11 in the first direction with respect to the protector body 51 and configured to accommodate the bent plate portion 33 and at least one deflection piece 62 extending from the protector body 51 and deflectable and deformable in the second direction (vertical direction) orthogonal to the first direction. The deflection piece 62 includes the plurality of plate portions 63 extending in the first direction and arranged apart in the second direction and at least one coupling portion 64 coupling the end parts in the first direction of two adjacent ones of the plate portions 63. The plurality of plate portions 63 include at least the base end side plate portion 63B to be connected to the protector body 51 and the tip side plate portion 63A to be disposed to face the terminal 30. The tip side plate portion 63A includes the locking portion 65A to be disposed in the recess 56 and locked to the bent plate portion 33 from the side (front side) opposite to the laminated batteries 11 in the first direction. The deflection piece 62 has the bellows shape by alternately connecting the plate portions 63 and the coupling portion 64 from the base end side plate portion 63B to the tip side plate portion 63A.

According to this configuration, since the deflection piece 62 includes the plurality of plate portions 63 and at least one coupling portion 64 coupling the two adjacent plate portions 63 and has the bellows shape, stress necessary to deflect the deflection piece 62 can be reduced. Therefore, in mounting the terminal 30 into the protector 50 by inserting the bent plate portion 33 into the recess 56, the bending of the terminal 30 can be suppressed.

In the first embodiment, the protector 50 is formed with the plurality of electrode accommodation recesses 52 penetrating through the protector body 51 in the first direction to accommodate the electrode leads 12, and the plurality of electrode accommodation recesses 52 are arranged in the third direction (lateral direction) orthogonal to both the first and second directions, and the deflection piece 62 is disposed between two adjacent ones of the electrode accommodation recesses 52.

According to this configuration, since the plurality of electrode accommodation recesses 52 are arranged in the third direction, this wiring module 20 is attached to the battery stack 11L in which the plurality of laminated batteries 11 are stacked in the third direction. Since a space extending in the first and second directions is formed between the electrode leads 12 adjacent in the third direction, a deflection margin of the deflection piece 62 can be increased by disposing the deflection piece 62 in this space. Further, the wiring module 20 can be reduced in size.

In the first embodiment, the tip side plate portion 63A is connected to the coupling portion 64 on the end part opposite to the laminated batteries 11 in the first direction.

According to this configuration, in inserting the bent plate portion 33 into the recess 56, the bent plate portion 33 can be suppressed from being erroneously inserted between the tip side plate portion 63A and the plate portion 63 adjacent to the tip side plate portion 63A.

In the first embodiment, the tip side plate portion 63A includes the locking projection 65 projecting from the tip side plate portion 63A toward the side (upper side) opposite to the base end side plate portion 63B in the second direction, the locking projection 65 includes the locking portion 65A disposed on the side of the laminated batteries 11 in the first direction and the inclined portion 65B disposed further on the side opposite to the laminated batteries 11 in the first direction than the locking portion 65A, and the inclined portion 65B is located more away from the base end side plate portion 63B in the second direction toward the laminated batteries 11 in the first direction.

According to this configuration, the insertion of the bent plate portion 33 into the recess 56 and the locking of the bent plate portion 33 and the locking portion 65A can be smoothly performed by the inclined portion 65B.

In the first embodiment, the protector 50 includes the guide portion 60 connected to the inner wall 59 (first inner wall 59A) of the recess 56 further on the side opposite to the laminated batteries 11 in the first direction than the recess 56, and the guide portion 60 is inclined inwardly of the recess 56 toward the laminated batteries 11 in the first direction.

According to this configuration, the insertion of the bent plate portion 33 into the recess 56 can be guided by the guide portion 60.

In the first embodiment, the protector 50 includes the deflection piece accommodation recess 61 recessed from the protector body 51 toward the laminated battery 11 in the first direction and configured to accommodate a part of the deflection piece 62.

According to this configuration, the part of the deflection piece 62 can be protected by accommodating the part of the deflection piece 62 into the deflection piece accommodation recess 61.

In the first embodiment, the terminal 30 is formed with at least one opening 36 penetrating through the bent plate portion 33, and the opening edge part of the opening 36 includes the lock receiving portion 36A to be locked to the locking portion 65A.

According to this configuration, the lock receiving portion 36A to be locked to the locking portion 65A can be easily provided by forming the opening 36 in the bent plate portion 33. Further, a space for locking the bent plate portion 33 and the locking portion 65A can be reduced.

### Second Embodiment

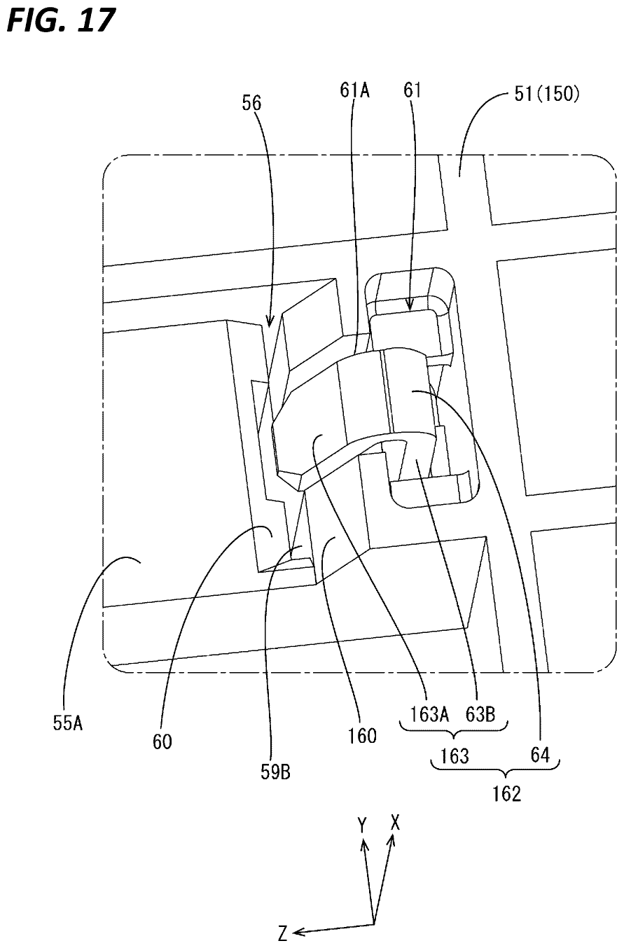

A second embodiment of the present disclosure is described with reference to FIGS. 17 to 19. Components similar to those of the first embodiment are denoted by the same reference signs as in the first embodiment and may not be described. Further, functions and effects similar to those of the first embodiment are not described. As shown in FIG. 17, a protector 150 according to the second embodiment includes a deflection piece 162 provided with a plurality of plate portions 163. The plurality of plate portions 163 include a tip side plate portion 163A and a base end side plate portion 63B.

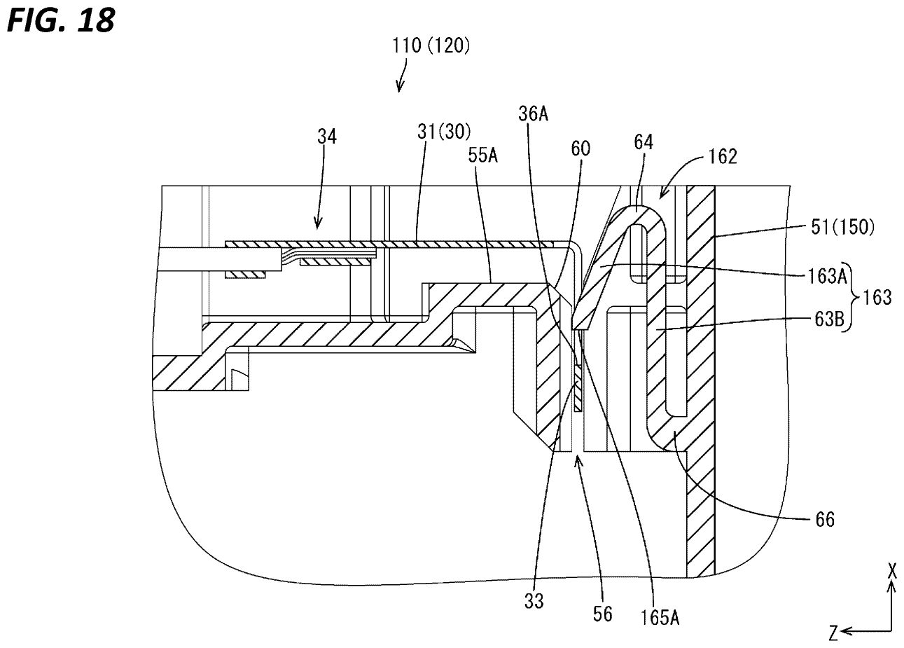

As shown in FIG. 18, the tip side plate portion 163A of the deflection piece 162 does not include the locking projection 65 according to the first embodiment. The tip side plate portion 163A is inclined to be located higher toward a rear side. In a power storage module 110 (wiring module 120) of the second embodiment, the rear end surface of the tip side plate portion 163A serves as a locking portion 165A lockable to a lock receiving portion 36A of a terminal 30. By inclining the tip side plate portion 163A in this way, a bent plate portion 33 is guided into a recess 56 as done by the inclined portion 65B of the locking projection 65 of the first embodiment.

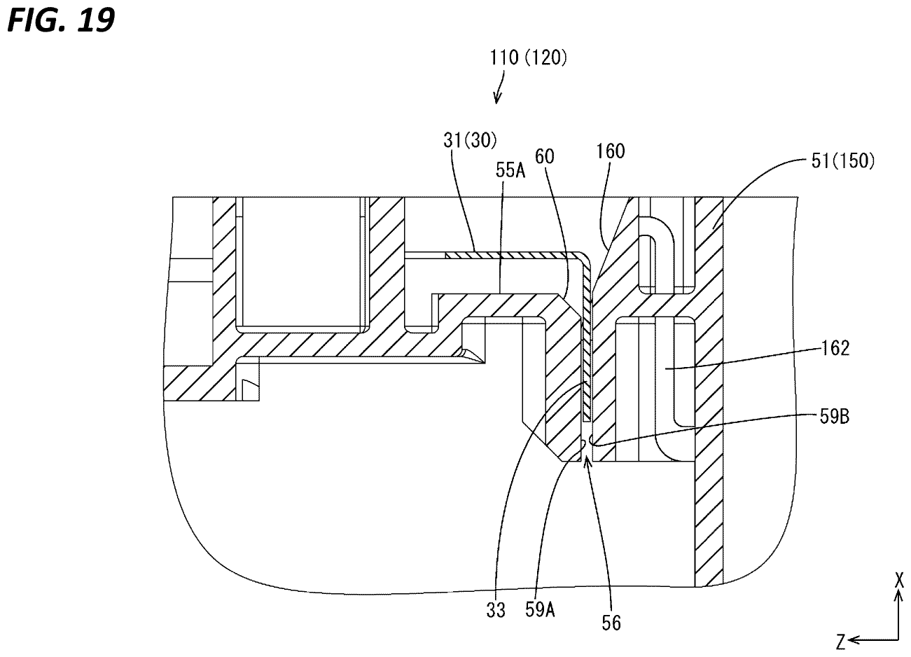

Further, as shown in FIG. 19, a guide portion 160 is formed to be continuous upward from a second inner wall 59B of the recess 56 in the second embodiment. The guide portion 160 is inclined to be located higher toward the rear side. The bent plate portion 33 can be guided into the recess 56 by bringing the bent plate portion 33 into sliding contact with the guide portion 160.

### [Functions and Effects of Second Embodiment]

According to the second embodiment, the following function and effect are achieved.

In the second embodiment, the tip side plate portion 163A is located more away from the base end side plate portion 63B in the second direction toward laminated batteries 11 in the first direction.

According to this configuration, the bent plate portion 33 can be smoothly inserted into the recess 56 by the tip side plate portion 163A.

### Third Embodiment

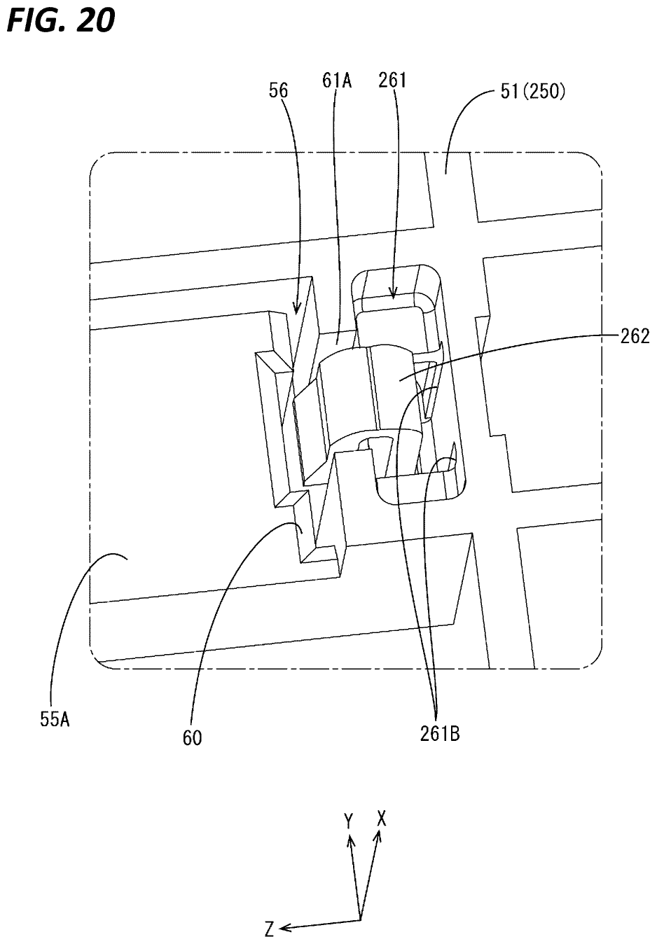

A third embodiment of the present disclosure is described with reference to FIGS. 20 to 22. Components similar to those of the first embodiment are denoted by the same reference signs as in the first embodiment and may not be described. Further, functions and effects similar to those of the first embodiment are not described. As shown in FIG. 20, a protector 250 according to the third embodiment includes a deflection piece 262. A deflection piece accommodation recess 261 of the protector 250 includes a pair of slits 261B in a lower inner wall facing an upper inner wall provided with an entrance opening 61A.

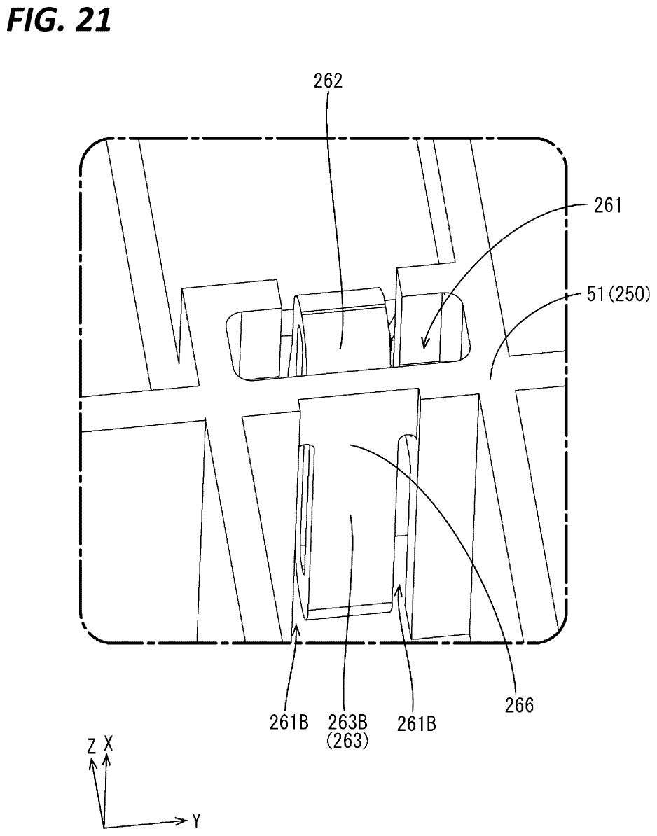

As shown in FIG. 21, the pair of slits 261B are formed to be elongated in the front-rear direction and disposed side by side in the lateral direction. The pair of slits 261B penetrate through the inner wall of the deflection piece accommodation recess 261 in the vertical direction and are open rearward. The inner wall of the deflection piece accommodation recess 261 sandwiched between the pair of slits 261B serves as a base end side plate portion 263B of the deflection piece 262. A front end part of the base end side plate portion 263B is connected to a protector body 51 via a base end connecting portion 266. By providing the pair of slits 261B in this way to form the base end side plate portion 263B constituted by a part of the inner wall of the deflection piece accommodation recess 261, a space for forming the deflection piece 262 can be reduced.

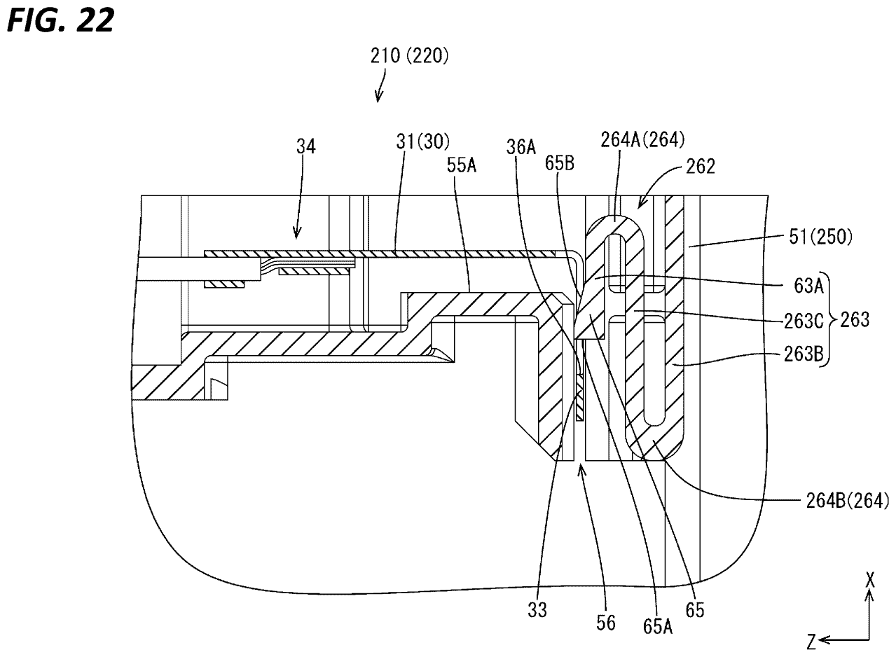

As shown in FIG. 22, the deflection piece 262 of this embodiment includes a plurality of (three) plate portions 263 and a plurality of (two) coupling portions 264. The plurality of plate portions 263 include a tip side plate portion 63A, the base end side plate portion 263B and an intermediate plate portion 263C disposed between the tip side plate portion 63A and the base end side plate portion 263B. The plurality of coupling portions 264 include a first coupling portion 364A coupling a front end part of the tip side plate portion 63A and a front end part of the intermediate plate portion 263C and a second coupling portion 264B coupling a rear end part of the intermediate plate portion 263C and a rear end part of the base end side plate portion 263B. In the deflection piece 262 of this embodiment, the plurality of plate portions 263 and the plurality of coupling portions 264 are arranged in the order of the base end side plate portion 263B, the second coupling portion 264B, the intermediate plate portion 263C, the first coupling portion 264A and the tip side plate portion 63A from a base end side (lower side) toward a tip side (upper side). That is, the deflection piece 262 is formed into a bellows shape by alternately disposing the plate portions 263 and the coupling portions 264 in the vertical direction in which the deflection piece 262 is deflected.

In a power storage module 210 (wiring module 220) of the third embodiment, when a terminal 30 is mounted into the protector 250, a rear end part of a bent plate portion 33 is pressed against an inclined portion 65B of a locking projection 65 from front and the deflection piece 262 is deflected downward. At this time, the plurality of plate portions 263 of the deflection piece 262 are more than the plurality of plate portions 63 of the first embodiment by one, stress applied to the terminal 30 from the deflection piece 262 is reduced as compared to the first embodiment. Further, since the base end side plate portion 263B is formed by cutting the inner wall of the deflection piece accommodation recess 261, a space taken up by the deflection piece 62 of the first embodiment and that taken up by the deflection piece 262 of the third embodiment are nearly equal.

### [Functions and Effects of Third Embodiment]

According to the third embodiment, the following function and effect are achieved.

In the third embodiment, the inner wall constituting the deflection piece accommodation recess 261 extends in the first direction and includes the pair of slits 261B disposed side by side in the third direction orthogonal to both the first and second directions, and the inner wall disposed between the pair of slits 261B serves as the base end side plate portion 263B.

According to this configuration, since the base end side plate portion 263B can be configured, utilizing the inner wall of the deflection piece accommodation recess 261, a space for forming the deflection piece 262 can be reduced.

### Other Embodiments

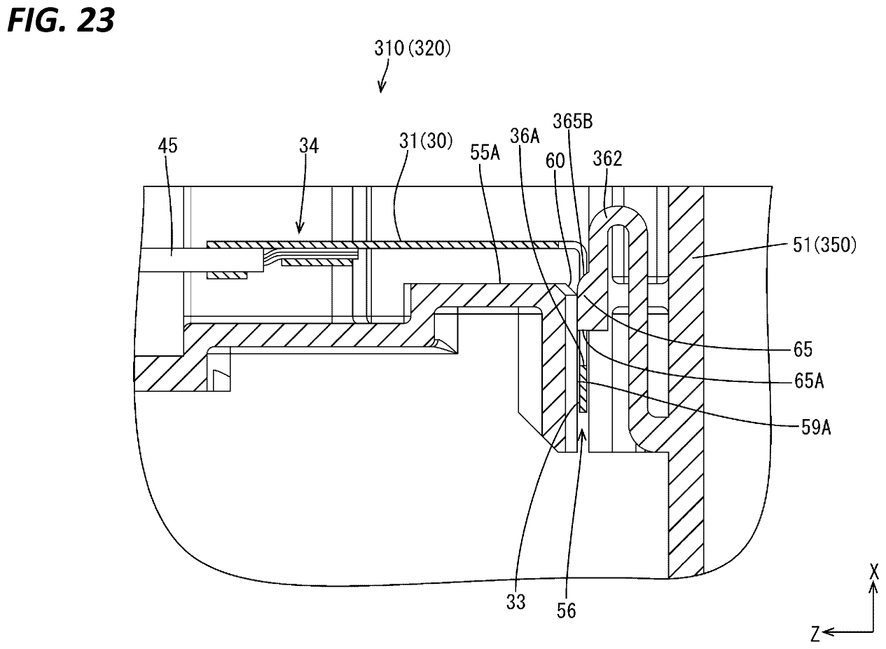

(1) Although the joining portion 13 are configured by joining the four electrode leads 12 in the above embodiments, there is no limitation to this. A joining portion only has to be configured by joining a plurality of electrode leads.
(2) Although the terminal 30 includes one lock receiving portion 36A and the protector 50, 150, 250 includes one deflection piece 62, 162, 262 for one terminal 30 in the above embodiments, there is no limitation to this. For example, a terminal may include two lock receiving portions and a protector may include two deflection pieces for one terminal.
(3) Although the terminal 30 includes the opening 36 and the opening edge part of the opening 36 includes the lock receiving portion 36A in the above embodiments, there is no limitation to this. For example, a terminal may include a lock receiving portion projecting from a bent plate portion without including an opening.
(4) Although the inclined portion 65B is formed into a flat surface in the above embodiments, there is no limitation to this. For example, as shown in FIG. 23, a protector of a power storage module 31 (wiring module 320) may include a deflection piece 362, and an inclined portion 365B of the deflection piece 362 may be formed into a curved surface.

### LIST OF REFERENCE NUMERALS

10, 110, 210, 310: power storage module
11: laminated battery
11L: battery stack
12: electrode lead
12A: connection electrode lead
12B: output electrode lead
13: joining portion
14: output portion
15: enclosure
15A: bottom portion
15B: ceiling portion
15C: side portion
20, 120, 220, 320: wiring module
30: terminal
31 body portion
32: connecting portion
33: bent plate portion
34: wire connecting portion
34A: base portion
34B: crimping piece
34C: first crimping piece
34D: second crimping piece
35: bent portion
36 opening
36A: lock receiving portion
36B: extended opening
40: busbar
40A: first part
40B: second part
41: busbar side connecting portion
41A: through hole
45: wire
46: core wire
47: insulation coating
48: connector
48A: housing
48B: male terminal
50, 150, 250, 350: protector
50A: routing recess
51 protector body
52: electrode accommodation recess
52A: connection electrode accommodation recess
52B: output electrode accommodation recess
53: busbar holding portion
53A: bolt fastening portion
54: terminal accommodating portion
55: body portion accommodating portion
55A: bottom wall portion
55B: left wall portion
55C: communication hole
56: recess
57: wire connecting portion accommodating portion
58: contact portion
59: inner wall
59A: first inner wall
59B: second inner wall
59C: side wall
60, 160: guide portion
61, 261: deflection piece accommodation recess
61A: entrance opening
62, 162, 262, 362: deflection piece
63, 163, 263: plate portion
63A, 163A: tip side plate portion
63B, 263B: base end side plate portion
64, 264: coupling portion
65: locking projection
65A, 165A: locking portion
65B, 365B: inclined portion
66, 266: base end connecting portion
261B: slit
263C: intermediate plate portion
264A: first coupling portion
264B: second coupling portion

1. A wiring module to be attached to a battery stack configured by stacking a plurality of laminated batteries including electrode leads, the battery stack including a joining portion formed by overlapping and joining the electrode leads of the laminated batteries, comprising:
a terminal;
a wire to be connected to the terminal; and
a protector for holding the terminal and the wire,
the terminal including a body portion, a connecting portion extending from the body portion and facing and connected to the electrode leads constituting the joining portion in a first direction, and a bent plate portion connected to the body portion via a bent portion and extending toward the laminated batteries in the first direction,
the protector including a protector body, a recess recessed toward the laminated batteries in the first direction with respect to the protector body, the recess accommodating the bent plate portion, and at least one deflection piece extending from the protector body and deflectable and deformable in a second direction orthogonal to the first direction,
the deflection piece including a plurality of plate portions extending in the first direction and arranged apart in the second direction and at least one coupling portion coupling end parts in the first direction of two adjacent ones of the plate portions,
the plurality of plate portions including at least a base end side plate portion to be connected to the protector body and a tip side plate portion disposed to face the terminal,
the tip side plate portion including a locking portion to be disposed in the recess and locked to the bent plate portion from a side opposite to the laminated batteries in the first direction, and
the deflection piece having a bellows shape by alternately connecting the plate portions and the coupling portion from the base end side plate portion to the tip side plate portion.

2. The wiring module according to claim 1, wherein:
the protector is formed with a plurality of electrode accommodation recesses penetrating through the protector body in the first direction, the electrode accommodation recesses receiving the electrode leads,
the plurality of electrode accommodation recesses are arranged in a third direction orthogonal to both the first and second directions, and
the deflection piece is disposed between two adjacent ones of the electrode accommodation recesses.

3. The wiring module according to claim 1, wherein the tip side plate portion is connected to the coupling portion on an end part opposite to the laminated batteries in the first direction.

4. The wiring module according to claim 1, wherein:
the tip side plate portion includes a locking projection projecting from the tip side plate portion toward a side opposite to the base end side plate portion in the second direction,
the locking projection includes the locking portion disposed on the laminated battery side in the first direction and an inclined portion disposed further on the side opposite to the laminated batteries in the first direction than the locking portion, and
the inclined portion is located more away from the base end side plate portion in the second direction toward the laminated batteries in the first direction.

5. The wiring module according to claim 1, wherein the tip side plate portion is located more away from the base end side plate portion in the second direction toward the laminated batteries in the first direction.

6. The wiring module according to claim 1, wherein:
the protector includes a guide portion disposed to be continuous with an inner wall of the recess further on a side opposite to the laminated batteries in the first direction than the recess, and
the guide portion is inclined inwardly of the recess toward the laminated batteries in the first direction.

7. The wiring module according to claim 1, wherein the protector includes a deflection piece accommodation recess recessed from the protector body toward the laminated batteries in the first direction, the deflection piece accommodation recess accommodating a part of the deflection piece.

8. The wiring module according to claim 7, wherein:
an inner wall constituting the deflection piece accommodation recess extends in the first direction and includes a pair of slits disposed side by side in a third direction orthogonal to both the first and second directions, and
the inner wall disposed between the pair of slits serves as the base end side plate portion.

9. The wiring module according to claim 1, wherein:
the terminal is formed with at least one opening penetrating through the bent plate portion, and
an opening edge part of the opening includes a lock receiving portion to be locked to the locking portion.
